(19) United States
(12) Patent Application Publication
(10) Pub. No.: US 2011/0250785 A1
(43) Pub. Date: Oct. 13, 2011

(54) AUTO-SWITCHING AUDIO SIGNAL CONNECTOR

(75) Inventor: Gavin Reid, Campbell, CA (US)

(73) Assignee: Apple Inc., Cupertino, CA (US)

(21) Appl. No.: 13/082,207

(22) Filed: Apr. 7, 2011

Related U.S. Application Data
(60) Provisional application No. 61/321,731, filed on Apr. 7, 2010.

(51) Int. Cl. H01R 3/00

(52) U.S. Cl. 439/488

(57) ABSTRACT

The disclosure describes an audio signal connector of a processor-based system for automatically determining an audio mode of the electronic device engaged with the audio signal connector. The processing system determines the audio mode by sensing the presence of a trigger provided in proximity to the sensor when a plug terminal is engaged with the audio signal connector.

### CLAIM OF PRIORITY

This application claims the benefit of priority under 35 U.S.C. §119(e) to U.S. Patent Application Ser. No. 61/321,731, filed Apr. 7, 2010, which is hereby incorporated by reference herein in its entirety.

### BACKGROUND

The present disclosure relates generally to audio connectors and methods of their operation, and more particularly relates to audio signal connectors configured to determine an audio mode of an electronic audio device coupled to the connector.

Many processor-based systems, such as mobile phones, digital media players, and computers of all types (desktops, laptops, tablets, etc.) and the like, have audio signal port connectors for audio input and/or output. Typically where both input and output must be provided for, devices provide one dedicated port for audio input and another dedicated port for audio output. With many processor-based systems becoming smaller and thinner relative to prior counterpart devices, inclusion of two separate ports can occupy space on the device surface and inside the device, that could be used to incorporate other ports or other hardware. With a reduction in the number of I/O ports, some processing systems can be configured smaller and thinner. Therefore, it would be desirable to be able to use a single audio signal connector for both audio input and output. However, use of a single audio port requires the user to select the proper operational mode (e.g., audio input or audio output) when engaging an audio electronic device with the processing system.

### SUMMARY

The disclosure describes an audio signal connector of a processor-based system for automatically determining an audio mode of the electronic device engaged with the audio signal connector. The processing system determines the audio mode by sensing the presence or absence of a trigger provided in proximity to a sensor when a plug terminal is engaged with the audio signal connector.

### BRIEF DESCRIPTION OF THE DRAWINGS

FIGS. 1A-B depict an example system with a plurality of input/output ports including an audio connector, illustrated from an oblique side view in FIG. 1A, and from a side view (and in a closed state) in FIG. 1B.

FIGS. 2A-B depict an example plug of an audio device operably engaged with an audio signal connector configured to automatically determine an audio mode of the device, illustrated in functional representation of a vertical cross-section in FIG. 2A, and in FIG. 2B in a vertical section representation perpendicular to the view of FIG. 2A.

FIG. 3A-B depict an alternative example plug of an audio device operably engaged with an audio signal connector automatically switchable to one of three modes.

FIG. 4 depicts a method of determining an audio mode of an electronic audio device operably engaged with a processing system.

FIG. 5 illustrates an apparatus for adapting a conventional audio device for use with an automatic detection audio connector, as described herein.

### DETAILED DESCRIPTION

The following detailed description refers to the accompanying drawings that depict various details of examples selected to show how particular embodiments may be implemented. The discussion herein addresses various examples of the inventive subject matter at least partially in reference to these drawings and describes the depicted embodiments in sufficient detail to enable those skilled in the art to practice the invention. Many other embodiments may be utilized for practicing the inventive subject matter than the illustrative examples discussed herein, and many structural and operational changes in addition to the alternatives specifically discussed herein may be made without departing from the scope of the inventive subject matter.

In this description, references to “one embodiment” or “an embodiment,” or to “one example” or “an example” mean that the feature being referred to is, or may be, included in at least one embodiment or example of the invention. Separate references to “an embodiment” or “one embodiment” or to “one example” or “an example” in this description are not intended to necessarily refer to the same embodiment or example; however, neither are such embodiments mutually exclusive, unless so stated or as will be readily apparent to those of ordinary skill in the art having the benefit of this disclosure. Thus, the present disclosure includes a variety of combinations and/or integrations of the embodiments and examples described herein, as well as further embodiments and examples as defined within the scope of all claims based on this disclosure, as well as all legal equivalents of such claims.

For the purposes of this specification, “computing device,” “computing system,” “processor-based system” or “processing system” includes a system that uses one or more processors, microcontrollers and/or digital signal processors and that has the capability of running a “program.” As used herein, the term “program” refers to a set of executable machine code instructions, and as used herein, includes user-level applications as well as system-directed applications or daemons, including operating system and driver applications. Processing systems can include communication and electronic devices, such as mobile phones (cellular or digital), music and multi-media players, electronic reading device, and Personal Digital Assistants (PDA); as well as computers, or “computing devices” of all forms (desktops, laptops, servers, palmtops, workstations, tablet devices, notebooks, netbooks, etc.).

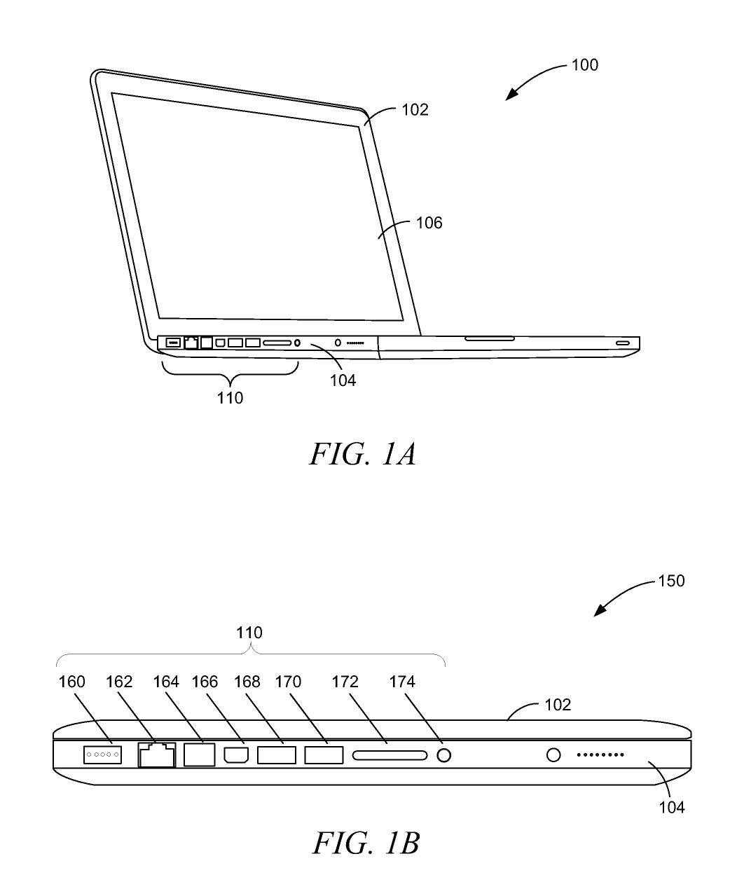

FIGS. 1A-B depict an example processing system 102 with a plurality of input/output (I/O) ports, the connectors of which are indicated at 110, and include an audio connector 174. As can be seen in the Figure, processing system 102 is in the example form of a notebook computer. For the purposes of this specification, the “I/O ports” include the components of a system 102 serving as a mechanical and electrical interface between the system 102 and external electrical devices, sometimes according to a specific protocol (e.g., USB, FireWire, etc.) and capable of physically and electrically coupling with connectors associated with electrical devices, either directly, or through a cable, dongle or similar mechanism; and thus includes the physical connector associated with that port type.

As noted above, inclusion of a port connector requires space both on an external surface, and internally, for the connector and dedicated circuitry or other hardware. Thus, unlike dedicated input and output audio ports, having a singular audio signal connector can assist with achieving a dimensionally compact system. Additionally, with a single audio connector 174, automatic detection of the audio mode of an audio device operably engaged with the system 102 will improve efficiencies for the user, and thus the user experience.

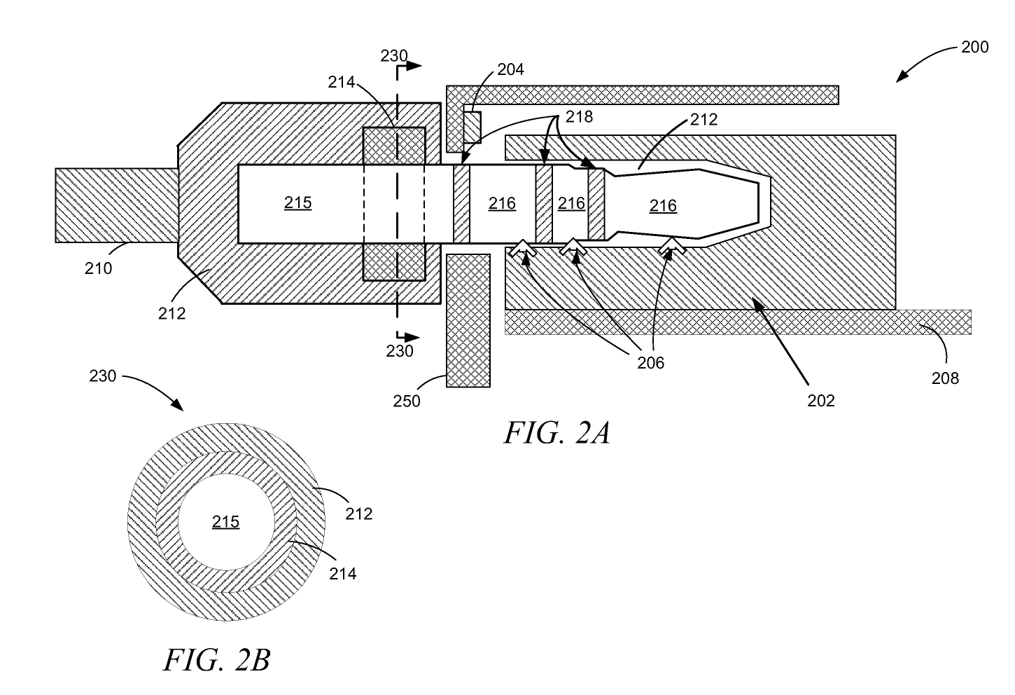

FIG. 2A depicts a cross-sectional view 200 of a block diagram representation of an audio plug 210 of an electronic audio device engaged with an audio signal connector 202 of a system 250. In this example, the audio signal connector 202 will respond to the presence or absence of a stimulus, or “trigger,” associated with an attached device to control the operational state of the connector. Audio signal connector 202 includes contact pins 206, located on an interior surface within audio plug receiving space 212, and positioned to engage with contact surfaces 216 of an audio plug 210. Contact pins 206 can be of any conventional physical design to electrically contact a compatible audio plug. Unlike conventional connectors, the functionality of pins 206 is based on the determined audio mode of the audio device.

The audio signal connector 202 includes a sensor 204 in communication with a processor of the system 250 through a communication portion 208, which is also operably connected to contacts 206 to control their functionality, as noted above. Sensor 204 is positioned proximate audio signal connector 202 in order to facilitate detection of a trigger 214 when the audio plug terminal 215 is engaged. In one configuration, upon detection of the trigger 214, the sensor 204 signals a change to communication portion 208 (depicted in block diagram form), which switches the audio signal connector from the “normal” default audio mode to the alternative audio mode, by changing the functionality of pins 206 from the default audio mode to the alternative mode. As an example, if the audio signal connector 202 is normally configured to receive an audio input (such as from a microphone or a line-in input), upon detection of the trigger 214, the processing system 250 (or other control mechanism) will switch the audio signal connector from the “audio in” mode to the alternative “audio out” mode. To make such switch of audio modes, the electrical connections of one or more of the contact pins 206 with internal circuitry will be changed such as, for example, from the “audio in” or “microphone” node of an IC or audio circuit to the “audio out” or “left channel audio out” of that or another IC or circuit.

Alternatively, in a second example the trigger 214 and sensor 204 combination can be configured such that when the trigger 214 is detected by the sensor 204, the system 250 maintains the “normal,” default audio mode of the audio signal connector 202. When an audio plug terminal 215 is engaged with audio signal connector 202 and a trigger 214 is not detected, the system 250 switches from the normal audio mode (e.g., audio input) to the alternative mode (e.g., audio output). Of course, either mode may be selected as the default operational mode, as may be desired for a particular type of device and its expected predominant usage.

Various devices can be used to form the compatible sensor 204 and trigger 214. For example, sensor 204 can include either a reed switch or a Hall effect sensor, and trigger 214 can be a permanent magnet. As an alternative embodiment, trigger 214 can include a coil which receives a bias provided through the connector 202, causing a current flow in the coil and generating a field detectable by the sensor 204. In the example of FIGS. 2A-B, trigger 214 is a permanent magnet that circumferentially surrounds the audio plug terminal 215 and is radially equidistant from the audio plug terminal 215. Such a configuration ensures that sensor 204 will detect trigger 214 when engaged with the audio signal connector 202, regardless of the orientation of the audio plug 210. Alternatively, equivalent or more complex trigger-sensor configurations may be used, as will be apparent to those of ordinary skill in the art having the benefit of this disclosure.

The audio signal connector 202 is in communication with communication portion 208 to permit electrical communication between at least some of the pins 206 and other components of the processing system 250. For example, communication portion 208 may be implemented by a processor (including the system processor), or may be implemented in hard-wired circuitry, to facilitate the necessary configuration of audio signal connector 202. In some examples, this configuration may be as simple as switching the circuitry (or equivalent functionality) to which contacts 206 are coupled, from audio receive circuitry to audio output circuitry (or vice versa). In general, in most examples, the control of communication portion 208, however that portion is implemented, will respond to a signal from sensor 204 to selectively establish communication with such conventional hardware or software that will provide the functionality to the audio signal connector in the same manner as if the audio signal connector 202 was a dedicated connector integral to the host system 250.

The plug receiving space 212 is sized and shaped to receive at least one variation of an audio plug terminal 215, such as a standard 3.5 mm, three-contact (e.g., tip, ring, sleeve (TRS)) audio plug terminal 215. While the 3.5 mm plug terminal is commonly used in audio devices and is a desirable configuration, other configurations, such as, by way of example only, those compatible with rather the 6.5 mm standard audio plug terminal or the 2.5 mm miniature audio plug terminal, or other forms of connector, including analog electrical connectors and digital connectors (including optical in and/or out connectors) are envisioned within the scope of the present disclosure. Furthermore, although FIG. 2A illustrates three contact surfaces 216, all configurable combinations of the number of contact surfaces and plug terminal sizes are envisioned within the scope of the present disclosure.

As illustrated, the insulative rings 218 separate plug terminal 215 to form independent contact surfaces 216. As depicted in the Figure, pins 206 are positioned on a bottom surface of audio signal connector 202, and engage surfaces of contact surfaces 216. Pins 206 can be formed to engage with greater surface area of the contact surfaces 216. For example, the pins 206 may be formed as generally annular structures such as an annular connector with a split or other structure to allow radial expansion and retraction, for establishing conductivity and assisting with retention.

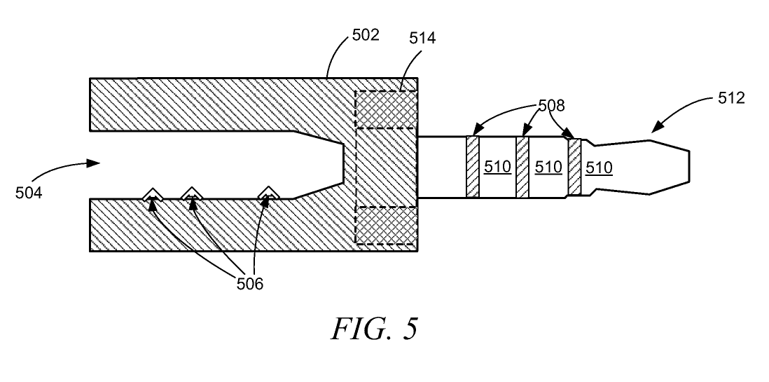

As illustrated in FIG. 2A, the sensor 204 can be placed on an internal wall of the casing of processor-based system 250 without obstructing the audio plug terminal 215 from properly engaging with the audio signal connector 202. Placement of the sensor 204 can be in any desired location so long as the location and positioning permits detection of the trigger 214 and does not disrupt any other functionality of the processing system 250. Trigger 214 is preferably incorporated within the audio device, such as in a cable connector overmold 212, and in a position that is in a detectable range of the sensor 204 when the audio plug terminal 215 is engaged with the audio signal connector 202. In various other configurations, trigger 214 can be a placed on an external surface of overmold 212, and in some embodiments. The placement of the trigger can depend on the sensitivity of the sensors 204 with which it is intended to function, and/or the strength (e.g., magnetic field) of the trigger 214. Various external configurations can allow for retrofitting an audio plug 210 with a trigger to permit automatically switching the audio mode of system 250 for existing audio devices. For example, a slip-on cover positionable over and snuggly fitting around the overmold 212 can incorporate a trigger similar in functionality to trigger 214. Alternatively, FIG. 5 depicts an adapter 500, that may be used, as will be addressed later herein.

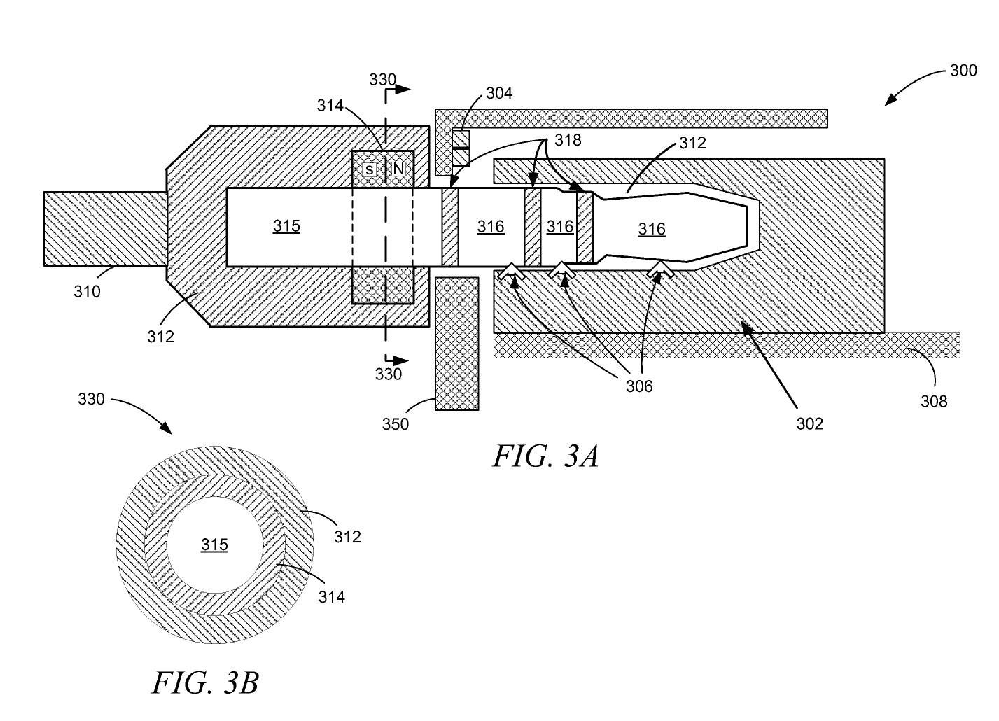

FIG. 3A illustrates another example mechanism for setting modes of an audio connector, in this case, a tri-modal trigger-sensor configuration. In this example, sensor 304 is sensitive to alternate states of a trigger, such as the polarity of a magnetic trigger 314. Thus, sensor can include two mono-polar sensors, each sensitive to a respective magnetic polarity (such as two reed switches of opposite sensitivities). Thus, audio input devices can include (for example) a N polarity pole closest to the pin, and audio receiving devices can include a S polarity pole closest to the pin, and the system will recognize each. This example, however, also detects a third state, detecting either electrically or mechanically the engagement of a connector with contacts 206, but the absence of a trigger 314. In this way, the system will recognize if a non-sensor-compatible device is connected to the audio connector, and respond appropriately. For example, the system may disconnect the contacts from internal circuitry, and/or may display a message to the user, and possibly offer a prompt or an option for the user to manually configure the audio connector, such as through a software interface.

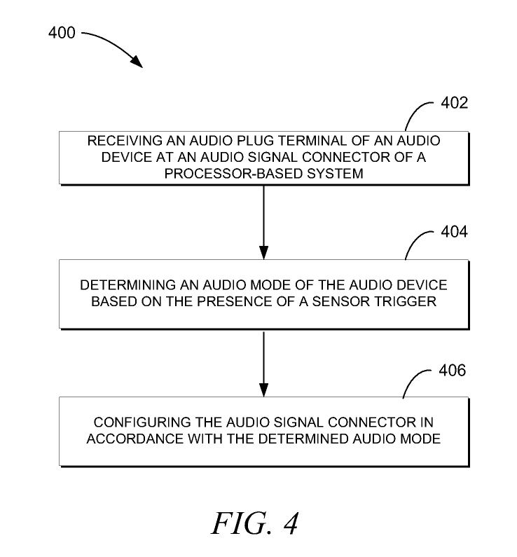

FIG. 4 depicts a method 400 of determining an audio mode of an electronic audio device. An audio plug terminal of the audio device is operably engaged with an audio signal connector of a processor-based system. At block 402, the method begins 400 begins by receiving an audio plug terminal of an audio device at the audio signal connector of the processor based system. At block 404 the method 400 determines an audio mode of the audio device based on the presence and/or other property of a sensor trigger (such as magnetic polarity). Finally, the system will configure the audio signal connector in accordance with the determined audio mode of the attached device.

FIG. 5 depicts an example adaptor 500 as might be used to provide the described trigger functionality to conventional audio input and receiving devices, illustrated partially in cut-away. Adaptor 500 includes a conventional pin receiving connector 504 operably coupled, such as through hard-wired connections to corresponding contact surfaces 510 on pin portion 512. Adaptor 500 also includes a trigger 514, which may be of any type as described previously herein. As is apparent form the preceding description, the adaptor should only be used with an appropriate type of audio device. But when so used, will enable the previously described auto configuration of the host system through the audio connector.

Various embodiments or combination of embodiments for apparatus and methods, as described herein, can be realized in hardware implementations, software implementations, and combinations of hardware and software implementations. Implementations including software will include a machine-readable medium having machine-executable instructions, such as a computer-readable medium having computer-executable instructions, for performing the described operations. The machine-readable medium is not limited to any one type of medium.

Although specific embodiments have been illustrated and described herein, it will be appreciated by those of ordinary skill in the art that any arrangement that is calculated to achieve the same purpose may be substituted for the specific embodiments shown. It is to be understood that the above description is intended to be illustrative, and not restrictive, and that the phraseology or terminology employed herein is for the purpose of description and not of limitation. Combinations of the above embodiments and other embodiments will be apparent to those of skill in the art upon studying the above description.

What is claimed is:

1. A processing system comprising:
an audio signal connector; and
a sensor positioned in proximity to the audio signal connector, the sensor configured to automatically determine an audio mode of an electronic device when a removable audio connector of the electronic device is operably coupled to the audio signal connector.

2. The processing system of claim 1, wherein the sensor comprises a Reed switch.

3. The processing system of claim 1, wherein the sensor comprises a Hall effect sensor.

4. The processing system of claim 1, wherein the sensor comprises a magnetic sensor.

5. The processing system of claim 1, wherein the audio mode of the electronic device is one of an audio input mode and an audio output mode.

6. The processing system of claim 1, wherein the sensor is configured to detect two or more audio modes for the electronic device.

7. An apparatus for determining an audio mode of a device connected to a processing system, the apparatus comprising:
a pin connector receptacle in electrical communication with components in a processing system; and
a sensor assembly positioned in operable relation to the receptacle portion, the sensor circuit configured to determine an operational mode of a pin connector engaged with the pin connector receptacle.

8. The apparatus of claim 7, wherein the operational mode is determined in relation to the detection of a sensor trigger associated with the pin connector when the pin connector is engaged with the pin connector receptacle.

9. The apparatus of claim 7, wherein the pin connector receptacle automatically determines a pin configuration for pins of the pin connector receptacle based on the determined operational mode.

10. The apparatus of claim 7, wherein the pin connector receptacle is an audio input port.

11. The apparatus of claim 7, wherein the sensor is magnetically operable.

12. The apparatus of claim 7, wherein the sensor is a reed switch.

13. The apparatus of claim 7, wherein the sensor is a Hall effect sensor.

14. A method of determining an audio mode, the method comprising:
receiving an audio connector of an electronic device at an audio receptacle of a processing system; and
determining an audio mode of the electronic device based on a sensor placed in proximity to the audio receptacle, and a presence of a sensor trigger of the audio connector.

15. The method of claim 14, wherein the audio mode is one of an audio input and an audio output.

16. The method of claim 14, wherein the sensor is a Reed switch and the sensor trigger is a magnet.

17. The method of claim 14, wherein the sensor is a Hall effect sensor and the sensor trigger is a magnet.

18. The method of claim 14, further comprising determining an operating pin configuration based on the determined audio mode.

19. The method of claim 14, further comprising switching an original audio mode of the receptacle when the sensor trigger is absent.

20. The method of claim 14, further comprising switching an original audio mode of the receptacle when the sensor trigger is present.

21. An apparatus for enabling device identification by a compatible sensor associated with an audio port of a processing system, comprising:
an electrical pin connector configured to engage the audio port; and
a trigger mechanism of a type that will enable detection by the sensor when the pin connector engages the audio port.

22. The apparatus of claim 21, wherein the trigger mechanism comprises a magnet.

23. The apparatus of claim 21, wherein the trigger mechanism is molded into a plastic overmold of the apparatus.

24. The apparatus of claim 21, wherein the apparatus further comprises a pin receptacle connector configured to receive the pin connector of an audio device, and wherein the pin receptacle is in electrical communication with the pin connector of the apparatus.
